(19) United States
(12) Patent Application Publication
(10) Pub. No.: US 2026/0089488 A1
(43) Pub. Date: Mar. 26, 2026

(54) METHOD FOR SWITCHING CLOUD SIM, AND ELECTRONIC DEVICE AND COMPUTER-READABLE STORAGE MEDIUM THEREFOR

(71) Applicant: Shanghai TUGE Data Technologies Co., Ltd., Shanghai (CN)

(72) Inventors: Kaihang WANG, Shanghai (CN); Hao ZHOU, Shanghai (CN)

(73) Assignee: Shanghai TUGE Data Technologies Co., Ltd., Shanghai (CN)

(21) Appl. No.: 19/333,300

(22) Filed: Sep. 18, 2025

Related U.S. Application Data
(63) Continuation of application No. PCT/CN2025/073527, filed on Jan. 21, 2025.

(30) Foreign Application Priority Data
Sep. 23, 2024 (CN) 202411320434.X

(51) Int. Cl. H04W 8/20; H04W 12/06; H04W 12/45; H04W 60/00

(52) U.S. Cl. CPC H04W 8/205; H04W 12/06; H04W 12/45; H04W 60/00

(57) ABSTRACT

The provided are a method for switching a cloud SIM, and an electronic device and a computer-readable storage medium therefor. In the method, a first MCC is identified, whether the identified first MCC matches a second MCC is determined, and a new cloud SIM corresponding to a country or region of the first MCC is assigned to the electronic device in a case where the first MCC does not match the MCC. The country or region where the electronic device is located is determined using the MCC from the network identifier acquired during the connection process between the seed SIM and the cloud SIM server. This enables rapid and accurate identification of the cross-border movement of the electronic device and facilitates timely replacement of the cloud SIM in the electronic device. Consequently, while ensuring operational convenience, this method effectively improves use experience of the device and saves tariffs.

### CROSS-REFERENCE TO RELATED APPLICATIONS

This application is a continuation application of International Application No. PCT/CN2025/073527, filed on January 21, 2025, which is based upon and claims priority to Chinese Patent Application No. 202411320434.X, filed on September 23, 2024, the entire contents of which are incorporated herein by reference.

### TECHNICAL FIELD

The present disclosure relates to the technical field of communications, and in particular, relates to a method for switching a cloud SIM, and an electronic device and a computer-readable storage medium therefor.

### BACKGROUND

With the continuous advancement of science and technology, transportation has become increasingly convenient, leading to more frequent travel for people between different countries and regions.

Conventionally, for network connectivity for a mobile device across different service areas, a user is required to manually replace a subscriber identity module (SIM) in the device or purchase an additional portable Wi-Fi device (mobile hotspot). This method is highly inconvenient in practical application and fails to meet the user's need for simple and convenient operation. Alternatively, when a device utilizes a single SIM to achieve network connectivity by roaming across different service areas, high roaming fees are incurred. This is because roaming between networks of different operators relies on roaming agreements therebetween, a process that generates substantial costs and consequently leads to higher telecommunication expenses.

To address the above problems, cloud SIM communication has been proposed in related arts to provide communication services. Cloud SIM communication is a digital SIM service based on the cloud computing technology. The cloud SIM communication transforms a traditional physical SIM into a virtual, electronic SIM and enables global communication based on a cloud-based service. This allows users to use their devices across different countries and regions without manually replacing the physical SIM or purchase an additional portable Wi-Fi device. In this way, high roaming fees are avoided.

### SUMMARY

In view of the above-mentioned deficiencies in the related art, the present disclosure provides a method for switching a cloud SIM, an electronic device and a computer-readable storage medium therefor that may identify cross-border movement of a device in real-time and rapidly, accelerate the efficiency of cloud SIM switching during the cross-border process, and enhance the user experience.

In a first aspect, embodiments of the present disclosure provide a method for switching a cloud SIM, applied in an electronic device, the electronic device including a seed SIM capable of implementing global roaming. The method includes:

identifying a first mobile country code (MCC), wherein the first MCC is an MCC in a network identifier during a connection process between the seed SIM and a cloud SIM server;

determining whether the identified first MCC matches a second MCC, wherein the second MCC is an MCC corresponding to an original cloud SIM used by the electronic device; and

in a case where the first MCC does not match the second MCC, assigning a new cloud SIM corresponding to a country or region of the first MCC to the electronic device.

In some embodiments, the seed SIM is a global roaming virtual SIM.

In some embodiments, identifying the first MCC includes:

acquiring, by the cloud SIM server, the network identifier during the connection process between the seed SIM and the cloud SIM server; and

identifying the MCC in the network identifier as the first MCC.

In some embodiments, the method further includes:

in a case where the first MCC matches the second MCC, not switching the original cloud SIM in the electronic device.

In some embodiments, in a case where the first MCC matches the second MCC, the method further includes:

deactivating the original cloud SIM used by the electronic device.

In some embodiments, the method further includes:

in an initial state of the electronic device, connecting, by the electronic device, to the cloud SIM server via the seed SIM;

assigning a cloud SIM corresponding to a country or region where the electronic device is located to the electronic device based on the first MCC; and

performing network registration for the assigned cloud SIM via a network of the seed SIM.

In some embodiments, in a case where a new cloud SIM corresponding to the country or region is assigned to the electronic device based on the first MCC, the method further includes:

performing network registration for the new cloud SIM via a network of the seed SIM.

In some embodiments, performing the network registration for the new cloud SIM via the network of the seed SIM includes

sending, via the network of the seed SIM, a network registration request for the new cloud SIM; and upon receiving the network registration request for the new cloud SIM, obtaining authentication request information issued by the network of the seed SIM;

transmitting, using a data service of the seed SIM, the authentication request information to the cloud SIM server for authentication, and acquiring an authentication result upon authentication by the cloud SIM server; and

transmitting the authentication result to the network of the seed SIM, wherein authentication is successful when the authentication result matches an expected result in the network of the seed SIM, such that the network of the seed SIM accepts the network registration request for the new cloud SIM;

wherein in a case where the network of the seed SIM accepts the network registration request for the new cloud SIM, the network registration for the new cloud SIM is successful.

In a second aspect, embodiments of the present disclosure further provide an electronic device. The electronic device includes:

a dual-SIM communication module, including a seed SIM setting unit and a cloud SIM setting unit, wherein the seed SIM setting unit is configured to set a seed SIM capable of implementing global roaming;

a country code identification module, configured to identify a first MCC and determine whether the identified first MCC matches a second MCC, wherein the first MCC is an MCC in a network identifier during connection process between the seed SIM and a cloud SIM server, and the second MCC is an MCC corresponding to an original cloud SIM in the cloud SIM setting unit; and

a cloud SIM control module, configured to, in a case where the identified first MCC does not match the second MCC, switch the original cloud SIM in the cloud SIM setting unit to a new cloud SIM corresponding to a country or region assigned based on the first MCC.

In some embodiments, the seed SIM is a global roaming virtual SIM.

In some embodiments, in a case where the first MCC matches the second MCC, the cloud SIM control module is configured to not switch the original cloud SIM in the cloud SIM setting unit.

In some embodiments, in a case where the first MCC does not match the second MCC, the cloud SIM control module is further configured to deactivate the original cloud SIM used by the electronic device.

In some embodiments, in an initial state, the dual-SIM communication module is configured to cause the seed SIM in the seed SIM setting unit to be connected to the cloud SIM server, and acquire, based on the first MCC, a cloud SIM corresponding to a country or region where the electronic device is located; wherein network registration for the cloud SIM is performed via a network of the seed SIM.

In some embodiments, the cloud SIM control module is further configured to perform network registration for the new cloud SIM via a network of the seed SIM.

In a third aspect, embodiments of the present disclosure further provide a computer-readable storage medium storing one or more executable instructions, wherein the one or more executable instructions, when loaded and executed by a computer, cause the computer to perform the method according to the first aspect.

Evidently, in the technical solutions described above, the country or region where the electronic device is located is determined using the MCC from the network identifier acquired during the connection process between the seed SIM and the cloud SIM server. This enables real-time, rapid, and accurate identification of the cross-border movement of the electronic device and facilitates timely replacement of the cloud SIM in the electronic device. Consequently, while ensuring operational convenience, this method effectively improves use experience of the device and saves tariffs.

### BRIEF DESCRIPTION OF THE DRAWINGS

The inventive concept, specific structure and the technical effects of the present disclosure are further described hereinafter with reference to the accompanying drawings, for the purpose of better and sufficiently understanding the objective, features and technical effects of the present disclosure.

FIG. 1 is a schematic flowchart of a method for switching a cloud SIM according to some embodiments of the present disclosure;

FIG. 2 is a schematic flowchart of switching a cloud SIM according to some embodiments of the present disclosure; and

FIG. 3 is a schematic structural diagram of an electronic device according to some embodiments of the present disclosure.

### DETAILED DESCRIPTION OF THE EMBODIMENTS

For clearer descriptions of the objectives, technical solutions, and advantages of the embodiments of the present disclosure, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. Based on the embodiments of the present disclosure, all other embodiments derived by those of ordinary skill in the art without any creative efforts shall fall within the protection scope of the present disclosure.

It should be noted that, in this specification, such relationship-related terms as "first" and "second" are only used to differentiate one entity or operation from another entity or operation, but are not intended to require or imply that there is a practical relationship or sequence between these entities or operations.

The inventor(s) of the present disclosure has found that in the related art, the assigned cloud SIM is typically a local virtual SIM of the current country, i.e., a SIM from a local operator. When the device crosses a border, the SIM from the local operator is often unable to register with a roaming network. As a result, the device needs to take a significant amount of time to identify the cross-border situation and initiate SIM switching. Consequently, users may fail to gain Internet access for an extended period of time and thus user experience is poor.

In technical solutions of the related art where a device utilizes a cloud SIM for Internet access, the assigned cloud SIM is generally a local virtual SIM of the current country, i.e., a SIM from a local operator. When the device crosses a border, the SIM from the local operator is often unable to register with a roaming network. As a result, the device takes a significant amount of time to identify the cross-border situation and initiate SIM switching. Consequently, users may fail to gain Internet access for an extended period of time.

In the technical solutions of the related art where a device uses a cloud SIM for Internet access, the assigned cloud SIM is generally a local virtual SIM for the current country. Compared to a roaming SIM, the local virtual SIM offers more affordable tariffs, enjoys higher network priority, and provides better speeds and a superior experience. However, when a device equipped with such a local virtual SIM crosses a border, the local virtual SIM may fail to register with a roaming network. Alternatively, due to the prioritization of its home network, the device may only attempt to register with a roaming network only in a case where the device fails to register with its home network. This also leads to a lengthy process for registering with a roaming network during cross-border travel. Furthermore, in the related art, the roaming switch on a device is often disabled for cost-control purposes. Therefore, even though the device manages to register with a cross-border network, the device still fails to access the Internet. Consequently, a method for rapidly identifying cross-border movement and accurately switching the cloud SIM is not available yet, which leads to a poor cross-border user experience.

In the related art, when a device configured with a local virtual SIM of the current country moves cross-border, cloud SIM switching is typically handled in the following ways:

(1) Using a registration timeout timer: After crossing a border, when the local virtual SIM loses its network connection (goes "out of service"), the device needs to monitor this state for 3 minutes or longer. Cloud SIM switching is only triggered when the timeout period expires without successful network registration. This approach forces the device to wait blindly for 3 minutes or more, which is a time-consuming process that leads to a poor user experience.

(2) Modifying a modem of a chip: During the cross-border process, cross-border network information is acquired from the chip and reporte. An upper-layer service then uses related policies and algorithms to determine whether the cross-border network is available prior to initiating cloud SIM switching. This method has drawbacks: code of the modem of the chip needs to be modified, which is cumbersome as different products and chipsets may require re-adaptation. Moreover, even in the case of having acquired cross-border network information, complex algorithms are still needed to ensure stable and reliable switching.

In summary, the cloud SIM switching solutions in the related art fail to provide users with a convenient and rapid user experience.

In view of this, the present disclosure provides a method for switching a cloud SIM, an electronic device, and a computer-readable storage medium. The solutions may rapidly identify cross-border movement. In a case where it is discovered that a cross-border network is available for registration, the MCC is identified to quickly find a new cloud SIM that matches the current region of the device. Then, the existing cloud SIM in the device is quickly switched to a local virtual SIM of the cross-border country, thereby effectively optimizing the user experience.

The above technical solutions are described in detail hereinafter with reference to specific embodiments.

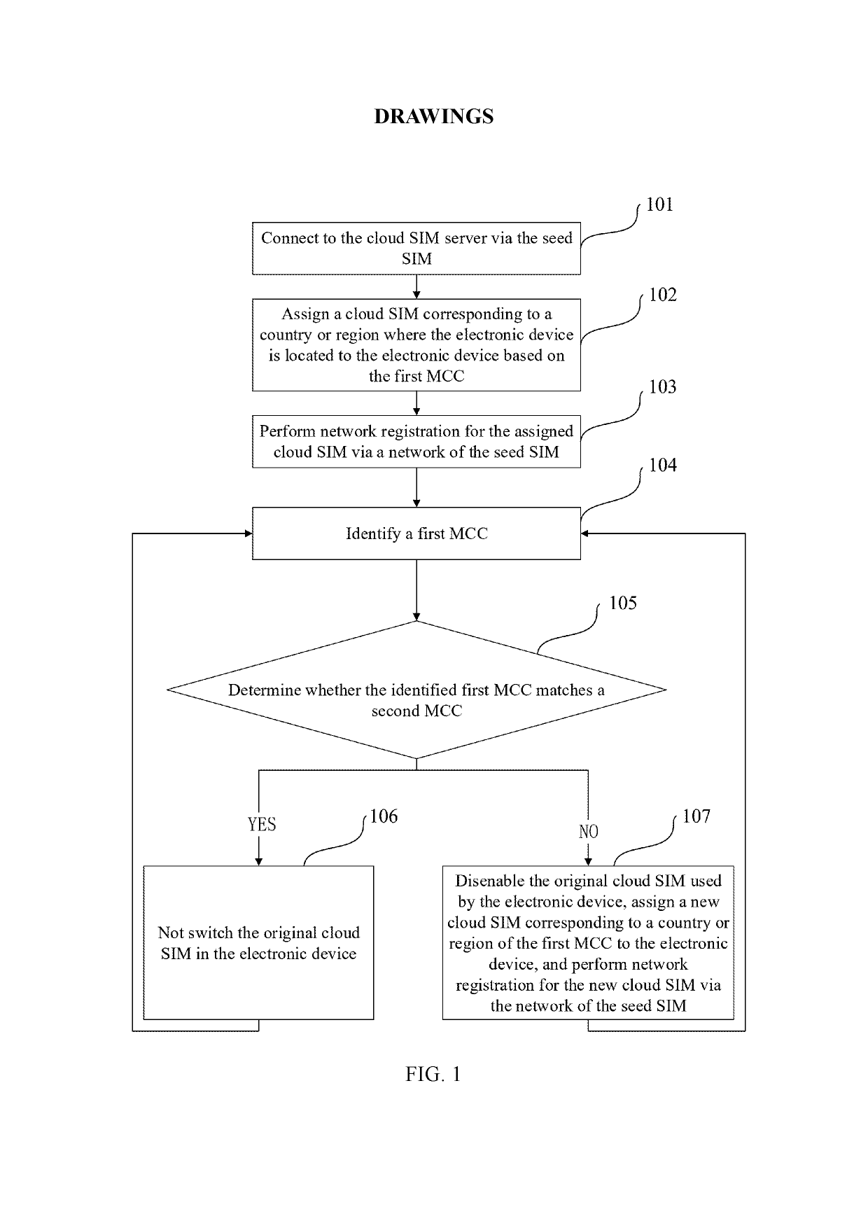

FIG. 1 is a schematic flowchart of a method for switching a cloud SIM according to some embodiments of the present disclosure.

The method for switching a cloud SIM according to the embodiments of the present disclosure is applied in an electronic device. The electronic device includes a seed SIM capable of implementing global roaming, wherein the seed SIM in the embodiments may be a global roaming virtual SIM.

The method includes the following steps.

In step 101, in an initial state, the electronic device is connected to the cloud SIM server via the seed SIM.

In step 102, a cloud SIM corresponding to a country or region where the electronic device is located is assigned to the electronic device based on the first MCC.

In step 103, network registration for the assigned cloud SIM is performed via a network of the seed SIM.

In step 104, a first MCC is identified, wherein the first MCC is an MCC in a network identifier during a connection process between the seed SIM and a cloud SIM server.

In step 105, whether the identified first MCC matches a second MCC is determined, wherein the second MCC is an MCC corresponding to an original cloud SIM used by the electronic device.

Specifically, determining whether the identified first MCC matches the second MCC includes: determining, by the electronic device, whether the identified first MCC matches the second MCC.

In step 106, in a case where the first MCC matches the second MCC, the original cloud SIM in the electronic device is not switched.

In step 107, in a case where the first MCC does not match the second MCC, the original cloud SIM used by the electronic device is disabled, a new cloud SIM corresponding to a country or region of the first MCC is assigned to the electronic device, and network registration for the new cloud SIM is performed via the network of the seed SIM.

In the method for switching a cloud SIM according to the embodiments, a cross-border determination is made by comparing the MCC from the network identifier acquired during the connection process between the seed SIM and the cloud SIM server with the MCC corresponding to the original cloud SIM used by the electronic device. In a case where the two MCCs do not match, the original cloud SIM is deactivated. The cloud SIM server then assigns a new cloud SIM, which matches the MCC acquired during the connection process between the seed SIM and the cloud SIM server, to the electronic device. This process ensures rapid switching of the cloud SIM in the electronic device, thereby effectively improving the efficiency of cross-border identification and optimizing the user experience.

Further, in a case where the electronic device acquires the MCC corresponding to its currently used cloud SIM (i.e., the second MCC), the MCC may be stored locally within the electronic device. This is to ensure that during the process of determining the identified first MCC and the second MCC, the real-time identified first MCC may be compared with the second MCC that is pre-stored in the electronic device. Furthermore, in a case where the electronic device switches the cloud SIM thereof, the MCC corresponding to the original cloud SIM may be deleted from the device, and the MCC corresponding to the new cloud SIM is then stored locally. This prepares the device for subsequent MCC comparisons. This operational approach reduces the needs for the electronic device to repeatedly identify the second MCC, thereby simplifying the identification process and further improving the efficiency of the cloud SIM switching.

In some embodiments, identifying the first MCC includes:

acquiring, by the cloud SIM server, the network identifier during the connection process between the seed SIM and the cloud SIM server; and

identifying the MCC in the network identifier as the first MCC.

In some embodiments, performing the network registration for the new cloud SIM via a network of the seed SIM includes:

sending, via the network of the seed SIM, a network registration request for the new cloud SIM; and upon receiving the network registration request for the new cloud SIM, acquiring authentication request information issued by the network of the seed SIM;

transmitting, using a data service of the seed SIM, the authentication request information to the cloud SIM server for authentication, and acquiring an authentication result upon authentication by the cloud SIM server; and

transmitting the authentication result to the network of the seed SIM, wherein authentication is successful in a case where the authentication result matches an expected result in the network of the seed SIM, such that the network of the seed SIM accepts the network registration request for the new cloud SIM;

wherein in a case where the network of the seed SIM accepts the network registration request for the new cloud SIM, the network registration for the new cloud SIM is successful.

To enable a person skilled in the art to better understand the present disclosure, further description is provided hereinafter in conjunction with some embodiments.

In the embodiments, the seed SIM capable of implementing global roaming is constituted by a global roaming seed SIM, which is configured within the electronic device. During operation, the electronic device also needs to register an additional, switchable cloud SIM.

During running of the electronic device, the global roaming seed SIM is configured to be connected to the cloud SIM server. The server determines the current country of the electronic device based on the network with which the seed SIM is registered. Then, the server assigns a local virtual SIM of that country (i.e., the cloud SIM) to the device. The download and authentication of the cloud SIM are conducted over the network provided by the global roaming seed SIM. In a case where the cloud SIM successfully registers with the network and establishes a data connection (dial-up is successful), the cloud SIM may be used for normal Internet access. The cloud SIM network is used for data consumption. During device operation, both SIMs (the global roaming seed SIM and the cloud SIM) need to remain online and to be properly registered with their respective networks.

During a cross-border process, as the global roaming seed SIM is capable of roaming across networks of different countries, when the electronic device moves from country A to country B, the roaming network in country A no longer meets the registration criteria, while the network in country B does. The global roaming seed SIM may then register with the roaming network of country B, successfully switching the registration to the network in country B.

During device operation, in a case where a change in the country code of the network with which the global roaming seed SIM is registered is detected, a cross-border event is immediately determined. In this case, the original cloud SIM is instantly deactivated, and the global roaming seed SIM is reconnected to the cloud SIM server to request a new cloud SIM. A new local virtual SIM for the post-cross-border country is then provided. This approach leverages the characteristic of the global roaming seed SIM to switch its registered roaming network during a cross-border event, allowing for timely detection of the network switching and prompt cloud SIM switching. Furthermore, the successful registration of the global roaming seed SIM, which enables the download of the new cloud SIM, ensures that the newly switched cloud SIM is also stably registered with the network of the current country.

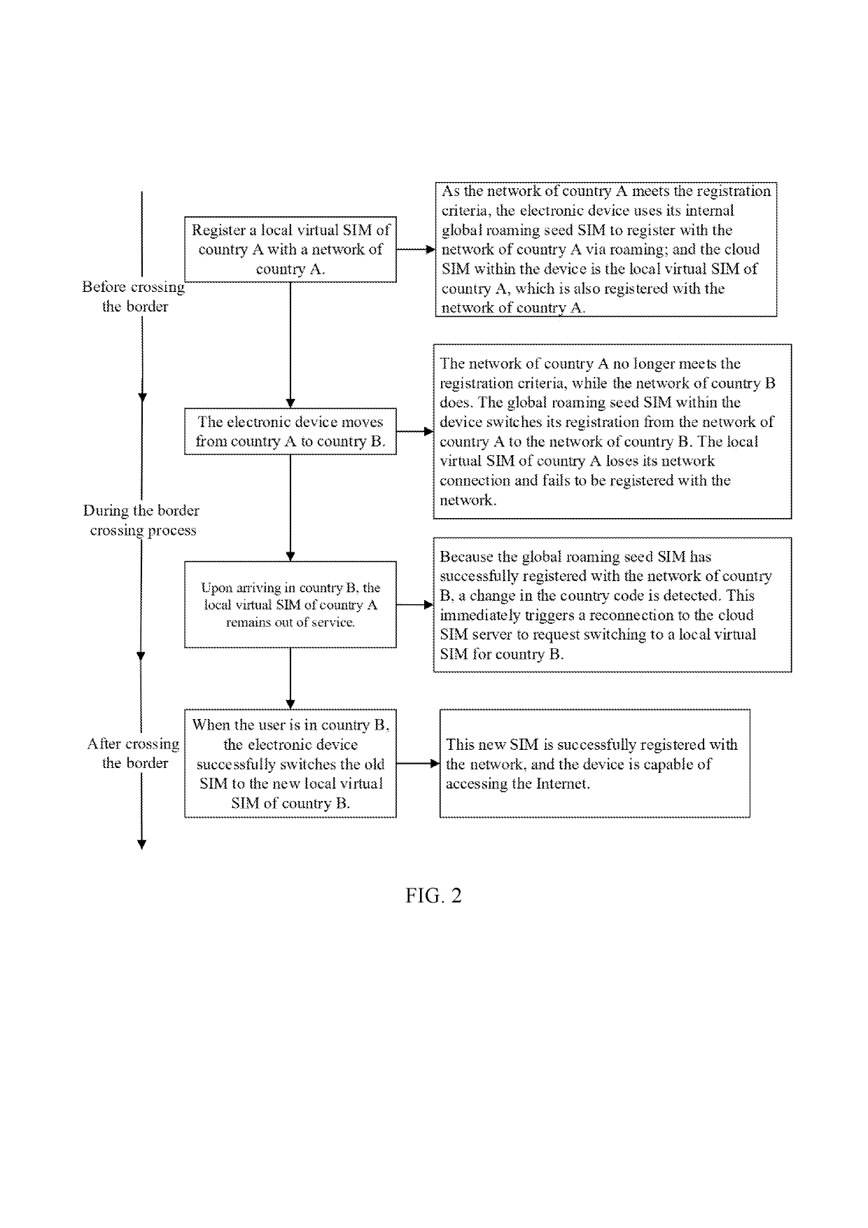

The process of switching a cloud SIM between two countries or regions is now further described with reference to FIG. 2, which is a schematic flowchart of a cloud SIM changing process according to some embodiments of the present disclosure.

When a user carries an electronic device which includes a global roaming seed SIM, and moves between country A and country B, the relevant operational flow is as follows:

Before crossing the border, when the electronic device is within the territory of country A, the electronic device registers a local virtual SIM of country A with the network of country A. During this stage, as the network of country A meets the registration criteria, the electronic device uses its internal global roaming seed SIM to register with the network of country A via roaming. The cloud SIM within the device is the local virtual SIM of country A, which is also registered with the network of country A.

During the border crossing process, as the user carries the electronic device from country A to country B, the network of country A no longer meets the registration criteria of the device, while the network of country B does. Consequently, the global roaming seed SIM within the device switches its registration from the network of country A to the network of country B. During this process, the local virtual SIM of country A loses its network connection ("goes out of service") and fails to be registered with the network.

Upon arriving in country B, the local virtual SIM of country A remains out of service. In this case, because the global roaming seed SIM has successfully registered with the network of country B, a change in the country code is detected. This immediately triggers a reconnection to the cloud SIM server to request switching to a local virtual SIM for country B.

After crossing the border, when the user is in country B, the electronic device successfully switches the old SIM to the new local virtual SIM of country B. This new SIM is successfully registered with the network, and the device is capable of accessing the Internet.

The core of the solution is to provide Internet access for an electronic device using a combination of a global roaming virtual SIM and a cloud SIM. The solution leverages the inherent characteristic of the global roaming virtual SIM to switch its registered network during cross-border roaming. Specifically, when the seed SIM (i.e., the global roaming virtual SIM) switches its registration from a public land mobile network (PLMN) of a first country to a PLMN of a second country, the current country code (i.e., the MCC) may be acquired from the newly registered PLMN. This serves to positively confirm that the device has switched to a new country. This confirmation, in turn, promptly triggers the switching of the cloud SIM with a new one corresponding to the new MCC. By using this method, the cloud SIM switching achieves a significantly more accurate and reliable result.

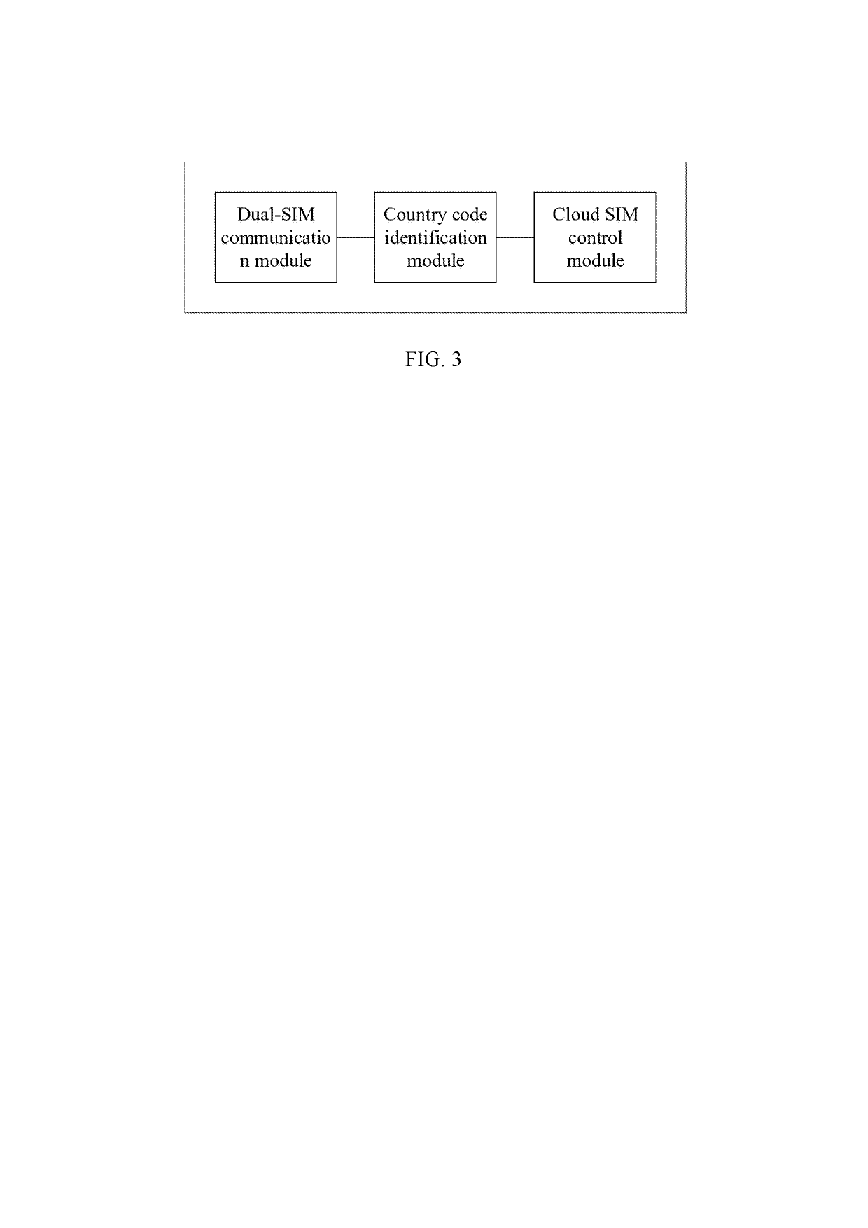

Some embodiments of the present disclosure further provide an electronic device. FIG. 3 is a schematic structural diagram of an electronic device according to some embodiments of the present disclosure.

The electronic device includes:

a dual-SIM communication module, including a seed SIM setting unit and a cloud SIM setting unit, wherein the seed SIM setting unit is configured to set a seed SIM capable of implementing global roaming;

a country code identification module, configured to identify a first MCC and determine whether the identified first MCC matches a second MCC, wherein the first MCC is an MCC in a network identifier during connection process between the seed SIM and a cloud SIM server, and the second MCC is an MCC corresponding to an original cloud SIM in the cloud SIM setting unit; and

a cloud SIM control module, configured to, in a case where the identified first MCC does not match the second MCC, switch the original cloud SIM in the cloud SIM setting unit to a new cloud SIM corresponding to a country or region assigned based on the first MCC.

In some embodiments, the seed SIM is a global roaming virtual SIM.

In some embodiments, in a case where the first MCC matches the second MCC, the cloud SIM control module is configured to not switch the original cloud SIM in the cloud SIM setting unit.

In some embodiments, in a case where the first MCC does not match the second MCC, the cloud SIM control module is further configured to deactivate the original cloud SIM used by the electronic device.

In some embodiments, in an initial state, the dual-SIM communication module is configured to cause the seed SIM in the seed SIM setting unit to be connected to the cloud SIM server, and acquire, based on the first MCC, a cloud SIM corresponding to a country or region where the electronic device is located; wherein network registration for the cloud SIM is performed via a network of the seed SIM.

In some embodiments, the cloud SIM control module is further configured to perform network registration for the new cloud SIM via a network of the seed SIM.

In the electronic device according to the embodiments, a cross-border determination is made by comparing the MCC from the network identifier acquired during the connection process between the seed SIM and the cloud SIM server with the MCC corresponding to the original cloud SIM used by the electronic device. In a case where the two MCCs do not match, the original cloud SIM is deactivated. The cloud SIM server then assigns a new cloud SIM, which matches the MCC acquired during the connection process between the seed SIM and the cloud SIM server, to the electronic device. This process ensures rapid switching of the cloud SIM in the electronic device, thereby effectively improving the efficiency of cross-border identification and optimizing the user experience.

In some embodiments, the electronic device further includes:

a second MCC storage module, configured to store an MCC corresponding to the cloud SIM currently used by the electronic device.

The country code identification module is further configured to, during determination on whether the identified first MCC matches the second MCC, determine the MCC corresponding to the cloud SIM currently used by the electronic device that is stored in the MCC storage module as the second MCC, and compare the second MCC with the identified first MCC to determine whether these two MCCs match.

In a case where a new cloud SIM is assigned to the electronic device, the corresponding MCC corresponding to the original cloud SIM card that is stored in the second MCC storage module may be deleted, and an MCC corresponding to the new cloud SIM card is used as the MCC corresponding to the cloud SIM card currently used by the electronic device, and stored in the second MCC storage module.

Some embodiments of the present disclosure further provide a computer-readable storage medium storing one or more executable instructions, wherein the one or more executable instructions, when loaded and executed by a computer, cause the computer to perform the method as described above.

For example, the computer-readable storage medium may include, but is not limited to, various known or unknown types of non-volatile memories.

Those skilled in the art may envisage that various exemplary units and algorithm steps described with reference to the embodiments of the present disclosure given herein may be practiced in the form of electronic hardware or a combination of software and electronic hardware. Whether such functions are implemented in the form of software or hardware depends on the specific application of the technical solutions and the design restrictions. Those skilled in the art may implement the described functions by using different methods for each specific application. However, such implementation shall not be deemed as going beyond the scope of the present disclosure.

In several embodiments of the present disclosure, it should be understood that the disclosed system, apparatus, and method may be implemented in other manners. For example, categorization of the functional units in the present disclosure is merely made in terms of logical functionality. In practice, the categorization of the apparatus may also be achieved in any other form. For example, a plurality of units or components may be combined or integrated into another system. Additionally, the coupling between the various units may be either direct coupling or indirect coupling. In addition, functional units in the embodiments of the present disclosure may be integrated into one processing unit, or may be separate physical units.

It should be understood that in various embodiments of the present disclosure, the sequence numbers of the above various processes or steps do not denote a preferred sequence of performing the processes or steps; and the sequence of performing the processes and steps should be determined according to the functions and internal logics thereof, which shall not cause any limitation to the implementation process of the embodiments of the present disclosure.

In the case that the functions are implemented in a form of a software functional unit and sold or used as an independent product, the units may be stored in a machine-readable storage medium. Therefore, the technical solutions of the present disclosure may be embodied in the form of a software product. This software product may be stored in a machine-readable storage medium and may include several instructions to cause an electronic device to perform all or part of the processes described in the embodiments of the present disclosure. The storage medium includes a ROM, a RAM, a magnetic disk, a compact disc read-only memory (CD-ROM), or the like medium which is capable of storing program code.

According to the present disclosure, the country or region where the electronic device is located is determined using the MCC from the network identifier acquired during the connection process between the seed SIM and the cloud SIM server. This enables rapid and accurate identification of the cross-border movement of the electronic device and facilitates timely replacement of the cloud SIM in the electronic device. Consequently, while ensuring operational convenience, this method effectively improves use experience of the device and saves tariffs.

Described above are merely specific embodiments of the present disclosure, and the scope of protection of the present disclosure are not limited thereto. Variations or substitutions that may be made by those skilled in the art within the technical scope disclosed in the present disclosure shall also fall within the scope of protection of the present disclosure.

1. A method for switching a cloud subscriber identity module (SIM), applied in an electronic device, the electronic device comprising a seed SIM configured for implementing global roaming, the method comprising:
identifying a first mobile country code (MCC), wherein the first MCC is an MCC in a network identifier during a connection process between the seed SIM and a cloud SIM server;
determining whether the first MCC matches a second MCC, wherein the second MCC is an MCC corresponding to an original cloud SIM configured by the electronic device; and
in a case where the first MCC does not match the second MCC, assigning a new cloud SIM corresponding to a country or region of the first MCC to the electronic device;
wherein identifying the first MCC comprises:
acquiring, by the cloud SIM server, the network identifier during the connection process between the seed SIM and the cloud SIM server; and
identifying the MCC in the network identifier as the first MCC.

2. The method according to claim 1, wherein the seed SIM is a global roaming virtual SIM.

3. The method according to claim 1, further comprising:
in a case where the first MCC matches the second MCC, not switching the original cloud SIM in the electronic device.

4. The method according to claim 1, wherein in a case where the first MCC matches the second MCC, the method further comprises:
deactivating the original cloud SIM configured by the electronic device.

5. The method according to claim 1, further comprising:
in an initial state of the electronic device, connecting, by the electronic device, to the cloud SIM server via the seed SIM;
assigning a cloud SIM corresponding to a country or region where the electronic device is located to the electronic device based on the first MCC; and
performing network registration for the cloud SIM via a network of the seed SIM.

6. The method according to claim 1, wherein in a case where the new cloud SIM corresponding to the country or region is assigned to the electronic device based on the first MCC, the method further comprises:
performing network registration for the new cloud SIM via a network of the seed SIM.

7. The method according to claim 6, wherein performing the network registration for the new cloud SIM via the network of the seed SIM comprises:
sending, via the network of the seed SIM, a network registration request for the new cloud SIM; and upon receiving the network registration request for the new cloud SIM, acquiring authentication request information issued by the network of the seed SIM;
transmitting, using a data service of the seed SIM, the authentication request information to the cloud SIM server for authentication, and acquiring an authentication result upon authentication by the cloud SIM server; and
transmitting the authentication result to the network of the seed SIM, wherein authentication is successful in a case where the authentication result matches an expected result in the network of the seed SIM, wherein the network of the seed SIM accepts the network registration request for the new cloud SIM;
wherein in a case where the network of the seed SIM accepts the network registration request for the new cloud SIM, the network registration for the new cloud SIM is successful.

8. An electronic device, comprising:
a dual-subscriber identity module (SIM) communication module, comprising a seed SIM setting unit and a cloud SIM setting unit, wherein the seed SIM setting unit is configured to set a seed SIM configured for implementing global roaming;
a country code identification module, configured to identify a first mobile country code (MCC) and determine whether the first MCC matches a second MCC, wherein the first MCC is an MCC in a network identifier during connection process between the seed SIM and a cloud SIM server, and the second MCC is an MCC corresponding to an original cloud SIM in the cloud SIM setting unit; and
a cloud SIM control module, configured to, in a case where the first MCC does not match the second MCC, switch the original cloud SIM in the cloud SIM setting unit to a new cloud SIM corresponding to a country or region assigned based on the first MCC;
wherein identifying the first MCC comprises:
acquiring, by the cloud SIM server, the network identifier during the connection process between the seed SIM and the cloud SIM server; and
identifying the MCC in the network identifier as the first MCC.

9. The electronic device according to claim 8, wherein the seed SIM is a global roaming virtual SIM.

10. The electronic device according to claim 8, wherein in a case where the first MCC matches the second MCC, the cloud SIM control module is configured to not switch the original cloud SIM in the cloud SIM setting unit.

11. The electronic device according to claim 8, wherein in the case where the first MCC does not match the second MCC, the cloud SIM control module is further configured to deactivate the original cloud SIM configured by the electronic device.

12. The electronic device according to claim 8, wherein in an initial state, the dual-SIM communication module is configured to cause the seed SIM in the seed SIM setting unit to be connected to the cloud SIM server, and acquire, based on the first MCC, a cloud SIM corresponding to a country or region where the electronic device is located; wherein network registration for the cloud SIM is performed via a network of the seed SIM.

13. The electronic device according to claim 8, wherein the cloud SIM control module is further configured to perform network registration for the new cloud SIM via a network of the seed SIM.

14. A computer-readable storage medium storing thereon one or more executable instructions, wherein the one or more executable instructions, when executed by a processor, cause the processor to perform the method according to claim 1.

15. The computer-readable storage medium according to claim 14, wherein in the method, the seed SIM is a global roaming virtual SIM.

16. The computer-readable storage medium according to claim 14, wherein the method further comprises:
in a case where the first MCC matches the second MCC, not switching the original cloud SIM in the electronic device.

17. The computer-readable storage medium according to claim 14, wherein in the method, in a case where the first MCC matches the second MCC, the method further comprises:
deactivating the original cloud SIM configured by the electronic device.

18. The computer-readable storage medium according to claim 14, wherein the method further comprises:
in an initial state of the electronic device, connecting, by the electronic device, to the cloud SIM server via the seed SIM;
assigning a cloud SIM corresponding to a country or region where the electronic device is located to the electronic device based on the first MCC; and
performing network registration for the cloud SIM via a network of the seed SIM.

19. The computer-readable storage medium according to claim 14, wherein in the method, in a case where the new cloud SIM corresponding to the country or region is assigned to the electronic device based on the first MCC, the method further comprises:
performing network registration for the new cloud SIM via a network of the seed SIM.

20. The computer-readable storage medium according to claim 19, wherein in the method, performing the network registration for the new cloud SIM via the network of the seed SIM comprises:
sending, via the network of the seed SIM, a network registration request for the new cloud SIM; and upon receiving the network registration request for the new cloud SIM, acquiring authentication request information issued by the network of the seed SIM;
transmitting, using a data service of the seed SIM, the authentication request information to the cloud SIM server for authentication, and acquiring an authentication result upon authentication by the cloud SIM server; and
transmitting the authentication result to the network of the seed SIM, wherein authentication is successful in a case where the authentication result matches an expected result in the network of the seed SIM, wherein the network of the seed SIM accepts the network registration request for the new cloud SIM;
wherein in a case where the network of the seed SIM accepts the network registration request for the new cloud SIM, the network registration for the new cloud SIM is successful.
